(19) United States
(12) Patent Application Publication
(10) Pub. No.: US 2026/0104382 A1
(43) Pub. Date: Apr. 16, 2026

(54) ION-SENSITIVE FIELD EFFECT TRANSISTORS

(71) Applicant: X-FAB Global Services GmbH, Erfurt (DE)

(72) Inventors: Alexander Zimmer, Uhlstädt-Kirchhasel (DE); Anna Hellegers Anak Achong, Kuching (MY); Alexander Hofmann, Erfurt (DE); Florian Kogler, Erfurt (DE)

(21) Appl. No.: 19/358,491

(22) Filed: Oct. 15, 2025

(30) Foreign Application Priority Data
Oct. 16, 2024 (DE) 102024130098.1

(51) Int. Cl. G01N 27/414

(52) U.S. Cl. CPC G01N 27/4148

(57) ABSTRACT

An ion sensitive field effect transistor (ISFET) for testing a medium, the ISFET comprises:
a substrate;
an active layer located on the substrate;
a source region and a drain region in the active layer;
a gate structure over a channel region between the drain region and the source region;
a backend stack comprising a plurality of metal layers, wherein the gate structure is directly connected to a top metal layer of the plurality of metal layers, and the drain region and source region are directly connected to one or more other metal layer or layers of said plurality of metal layers; and
a sensing layer covering the top metal layer, wherein the sensing layer comprises an anti-reflective coating (ARC) layer arranged to interface the medium.

### CROSS REFERENCE TO RELATED APPLICATIONS

This application claims the benefit of and priority to German Patent Application No. 102024130098.1, filed on Oct. 16, 2024, under 35 U.S.C. § 119 (b). The entire content of the foregoing application is incorporated herein by reference in its entirety.

### TECHNICAL FIELD

The present invention concerns Ion-Sensitive Field Effect Transistors (ISFETs).

### BACKGROUND

ISFETs are ion sensitive sensors that can be fabricated in CMOS using standard MOSFETs. pH-sensitive CMOS ISFETs with specific H+-ion-sensitive layers are manufactured using expensive and complex processes outside the standard CMOS process flows. CMOS ISFETs in standard/unmodified CMOS processes, on the other hand, can be produced inexpensively and are compatible with mass production that can make them accessible to a large number of different applications.

According to the current state of the art, the ion-sensitive layer of CMOS ISFETs consists of stacked layers of oxide and nitride passivation layers. However, the sensitivity and signal resolution of these (unmodified) CMOS ISFETs may be too low for some applications and hydration of the silicon nitride layer can lead to drifts and lower the lifetime of the ISFET.

Hence, there is a need to increase the sensitivity of the ISFET, while only requiring standard CMOS processes to make the ISFET.

### SUMMARY

Aspects of the present invention provide an ISFET and methods of making such as set out in the appended claims.

Specific embodiments are described below with reference to the accompanying drawings.

### BRIEF DESCRIPTION OF DRAWINGS

FIG. 1 shows a schematic cross section of a conventional ISFET;

FIG. 2 shows a schematic cross section of a CMOS ISFET;

FIG. 3 shows a schematic cross section of a CMOS ISFET with an ARC layer;

FIGS. 4A and 4B show two graphs of the material content as a function of depth for a silicon nitride ARC layer and a standard nitride layer respectively; and

FIG. 5 shows a flow diagram illustrating steps of a method of making an ISFET.

### DETAILED DESCRIPTION

To improve the CMOS ISFET, an anti-reflective coating (ARC) layer that interfaces the medium is added. The medium may be a fluid such as an ionic liquid. The CMOS ISFET sensor performance can be significantly improved in terms of sensitivity, resolution, and drift by adding an ARC layer, whereby the deposition of this layer is part of the standard/unmodified CMOS process and thus can remain cost-effective.

Testing a medium may comprise one or more of characterisation/determination of parameters, substances, substance mixtures or analytes in a medium. In one example, the medium is a substance or a mixture of substances in which ions are present as charge carriers, whose detection can be used to characterise the analyte contained in the medium or its parameters. The medium can be present in different states of aggregation, whereby fluidic, liquid and gaseous media may be predominantly to be analysed.

An analyte contained in the medium to be detected can be, for example, an ion as a charge carrier. The analyte can also be a substance contained in a mixture of substances. In more complex cases, the analyte in the medium can be, for example, a molecular structure, such as DNA, antibodies, antigens, proteins, enzymes and the like, which in turn contain charge carriers or generate charge carriers due to reactions with other biologically, chemically and/or biochemically functional structures. Similarly, the analyte can be a cellular structure that contains charge carriers or generates charge carriers due to reactions with other biologically, chemically and/or biochemically functional structures. The medium may also comprise combinations of such structures.

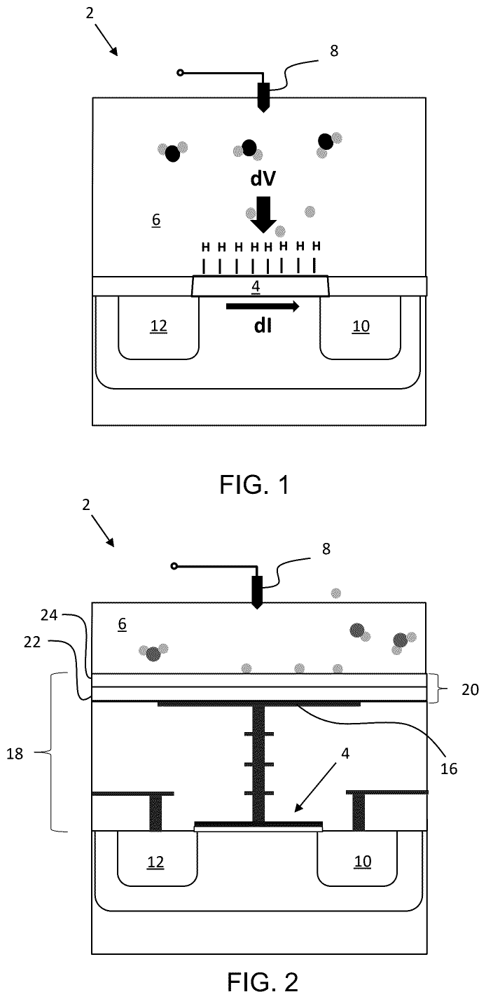

FIG. 1 shows a schematic cross section of a conventional ISFET 2 comprising an ion sensitive gate structure 4 interfacing a fluid 6 to be tested. A reference electrode 8 provides a bias voltage to the fluid 6. A current di flows between the source region 10 and drain region 12 of the ISFET. The magnitude of the current depends on the pH-level of the fluid 6 in contact with the gate structure 4.

FIG. 2 shows a schematic cross section of a CMOS ISFET 2. The same reference numerals have been used in different figures for similar or equivalent features to aid understanding and are not intended to limit the illustrated embodiments. The CMOS ISFET 2 is similarly arranged to measure the current through the transistor between the source region 10 and the drain region 12. The gate structure 4 is directly connected to the top metal layer 16 of the backend stack 18 of the CMOS device. A sensing layer 20 is arranged on the top metal layer 16, which is sensitive to the ion concentration of the fluid 6. The sensing layer comprises an oxide layer 22 and a nitride passivation layer 24 that interfaces the fluid 6.

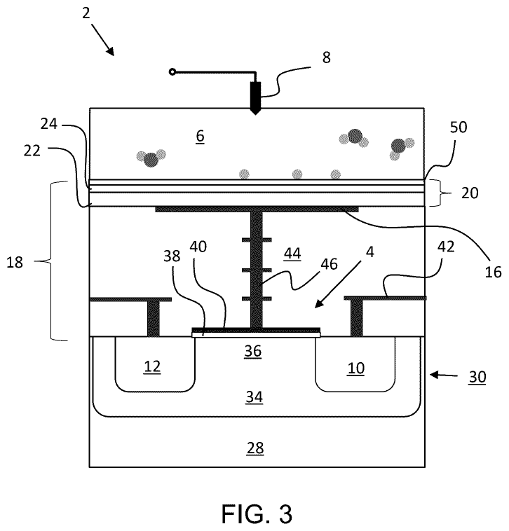

FIG. 3 shows a schematic cross section of a CMOS ISFET 2 with an ARC layer 50 to increase the sensitivity of the CMOS ISFET 2. The CMOS ISFET 2 comprises a substrate 28 (e.g. bulk silicon), an active layer 30 (e.g. epitaxial silicon) located on the substrate 28. In the active layer 30 there is a source region 10 and a drain region 12 in a doped well 34. For example, the source region 10 and the drain region 12 may be n-doped regions in a p-doped well.

The CMOS ISFET 2 further comprises a gate structure 4 over a channel region 36 between the drain region 10 and the source region 12. The gate structure 4 comprises a gate oxide layer 38 and a conductive gate layer 40 (e.g. a polysilicon layer) isolated from the active layer 30 by the gate oxide layer 38. The gate voltage that is applied to the conductive gate layer 40 changes the resistance in the channel region 36 and thereby causes a measurable change to the transistor current.

The CMOS ISFET 2 further comprises a backend stack 18 comprising a plurality of metal layers, wherein the drain region 10 and source region 12 are directly connected to the first metal layer 42 (Metal 1) and the gate structure 4 is directly connected to the top metal layer 16 (Metal 4) of the plurality of metal layers. The metal layers are separated by interlayer dielectric (ILD) oxide 44. The conductive gate layer 40 is connected to the top metal layer 16 by vias 46 between the metal layers. The metal layers and vias 46 typically comprise copper.

The CMOS ISFET 2 comprises a sensing layer 20 covering the top metal layer 16. The sensing layer 20 comprises an oxide layer 22 and a nitride passivation layer 24 (similar to the ISFET described in relation to FIG. 2 above). In addition, the sensing layer 20 comprises an anti-reflective coating (ARC) layer 50 arranged to interface the fluid 6. In an embodiment, the ARC layer 50 is a silicon nitride (Si3N4) layer (different from the underlying nitride passivation layer). The oxide layer 22 may have a thickness of about 700 nm.

The Si3N4 ARC layer is more nitrogen rich than standard Si3N4, thus having more potential binding sites for H+ ions to bind, which can lead to higher sensitivity compared to standard Si3N4 (e.g. as in the nitride passivation layer 24). The Si3N4 ARC layer is also more compressed compared to the nitride passivation layer 24 and therefore has fewer cracks into which ions and charged particles can penetrate. This can lead to reduced drift and to reduced noise, which can thereby provide improved signal resolution.

The higher compressive stress and the stoichiometric properties of the nitride ARC layer 50, which provide a lower refractive index (e.g. RI 1.92) compared to standard Si3N4 (RI 1.96), have been identified as beneficial to the ISFET performance.

Table 1 compares some performance metrics of a CMOS ISFET without ARC layer to those of a CMOS ISFET with a silicon nitride ARC layer. As can be seen, there is an improvement in sensitivity, resolution and drift.

TABLE 1

| Performance | CMOS ISFET | CMOS ISFET with ARC |
|---|---|---|
| Sensitivity (mV/pH) | 20-42 | 30-53 |
| Resolution (pH) | 0.013-0.1 | 0.002-0.01 |
| Drift (mV/h) | 90-2520 | 1-3 |

One of the reasons for the improvement in performance is the increased proportion of nitride in the ARC silicon nitride compared to standard (passivation nitride), and in particular an increase in nitride close to the surface of the layer (closer to the fluid interface).

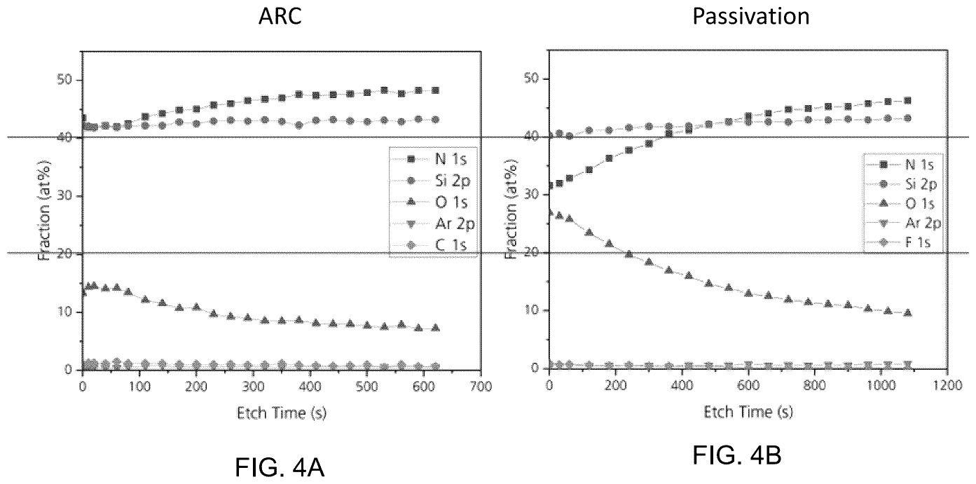

FIGS. 4A and 4B show graphs with the material content as a function of depth (expressed in etch time) of a Si3N4 ARC layer and a Si3N4 passivation layer respectively. As can be seen, close to the surface (short etch time), the ARC layer has a higher nitrogen content and lower oxygen content compared to the passivation layer.

In alternative embodiments, other materials may be used for the ARC layer 50. For example, the ARC layer may comprise SiO2 (RI 1.42-1.46), SiON (RI 1.90-1.94), SiON (RI 1.70-1.74), TiN, Ti or Ti/TiN or a composition including Ti.

The ARC module is an existing process module in CMOS processing for depositing an ARC layer, which is conventionally used to increase light transmission and improve the efficiency of optical semiconductor devices such as photodiodes, avalanche photodiodes (APDs), and single photon avalanche diodes (SPADs). Hence, this process module can be applied without modification to existing CMOS processing but for making ISFETs instead.

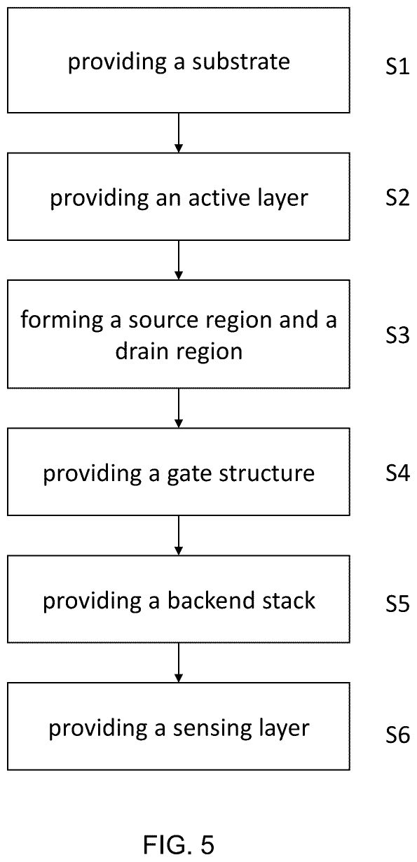

FIG. 5 is a flow diagram illustrating steps of a method of forming an ISFET. The method comprises providing a substrate (step S1), providing an active layer located on the substrate (step S2), forming a source region and a drain region in the active layer (step S3), and providing a gate structure over a channel region between the drain region and the source region (step S4). The method further comprises providing a backend stack comprising a plurality of metal layers, wherein the drain region and source region are directly connected to a first metal layer of the plurality of metal layers and the gate structure is directly connected to a top metal layer of the plurality of metal layers (step S5), and then providing a sensing layer covering the top metal layer, wherein the sensing layer comprises an anti-reflective coating (ARC) layer arranged to interface the fluid (step S6).

The ARC layer may be a silicon nitride layer. The deposition pressure when depositing the ARC layer may be lower than for standard Si3N4, and may have a lower gas flow, gas ratio and RF power.

In general, CMOS processing comprises a plurality of available process modules that can be combined, with some restrictions on the specific combinations and the order of the modules, to create different semiconductor structures. For example, there is a shallow trench isolation (STI) module for creating isolation in the active layer, and a MET1 module for depositing and patterning the lowermost metal layer that is directly connected to the active layer etc. Importantly, embodiments described herein can provide an improved ISFET, using only standard CMOS process modules. In one example, after applying the passivation module to form a passivation layer, the ARC module is applied to form an ARC layer over the passivation layer.

In general, according to a first aspect, embodiments described herein can provide an ion sensitive field effect transistor (ISFET) for testing a medium (e.g. measuring the pH level of a fluid), the ISFET comprising:
a substrate;
an active layer located on the substrate;
a source region and a drain region in the active layer;
a gate structure over a channel region between the drain region and the source region;
a backend stack comprising a plurality of metal layers, wherein the drain region and source region are directly connected to a first metal layer of the plurality of metal layers and the gate structure is directly connected to a top metal layer of the plurality of metal layers; and
a sensing layer covering the top metal layer, wherein the sensing layer comprises an anti-reflective coating (ARC) layer arranged to interface the medium.

The ARC layer may comprise silicon nitride and may have a refractive index in the range of 1.9 to 1.94. Alternatively, the ARC layer may comprise titanium or tantalum pentoxide.

The ARC layer may be a layer of
Si3N4, having a refractive index of 1.90-1.94;
SiO2 having a refractive index of 1.42-1.46;
SiON having a refractive index of 1.90-1.94; or
SiON having a refractive index of 1.70-1.74.

The ARC layer may comprise a composition of Ti. The ARC layer may be a layer of TiN, Ti, or Ti/TIN, for example.

The ARC layer may have a thickness in the range of 10 nm to 150 nm to provide suitable ion sensitivity.

The sensing layer may further comprise an oxide layer and a nitride passivation layer, wherein the oxide layer is in direct contact with top metal layer and the nitride passivation layer is located between the oxide layer and the ARC layer. The oxide layer and the nitride passivation layer may be formed in conventional CMOS processes. The nitride passivation layer may have a thickness in the range of 650 nm to 1,000 nm. For example, the nitride passivation layer may have a thickness of about 900 nm. A thinner passivation layer may increase the sensitivity of the ISFET. The oxide layer may have a thickness in the range of 500 nm to 1,100 nm (e.g. about 700 nm).

According to a second aspect, embodiments described herein may provide a method of making an ion sensitive field effect transistor (ISFET), the method comprising:
providing a substrate;
providing an active layer located on the substrate;
forming a source region and a drain region in the active layer;
providing a gate structure over a channel region between the drain region and the source region;
providing a backend stack comprising a plurality of metal layers, wherein the drain region and source region are directly connected to a first metal layer of the plurality of metal layers and the gate structure is directly connected to a top metal layer of the plurality of metal layers; and
providing a sensing layer covering the top metal layer, wherein the sensing layer comprises an anti-reflective coating (ARC) layer arranged to interface the medium.

The method may be used to make an ISFET according to the first aspect described above. The method comprises forming a transistor and then forming a sensing layer, wherein the sensing layer comprises an ARC layer for interfacing with the medium. The sensing layer is connected to the gate of the transistor through the metal layers in the backend stack and through vias between the metal layers.

The ARC layer may comprise silicon nitride and may have a refractive index in the range of 1.9 to 1.94. Providing the sensing layer may comprise depositing silicon nitride in a complementary metal oxide semiconductor (CMOS) plasma enhanced chemical vapour deposition (PECVD) process to form the ARC layer. The depositing may comprise depositing at a temperature in the range of 300° C. to 400° C. Alternatively, the ARC layer may comprise titanium or tantalum pentoxide.

The ARC layer may have a thickness in the range of 10 nm to 150 nm.

Providing the sensing layer may further comprise providing an oxide layer and a nitride passivation layer, wherein the oxide layer is in direct contact with top metal layer and the nitride passivation layer is located between the oxide layer and the ARC layer.

According to another aspect, embodiments described herein can provide a complementary metal oxide semiconductor (CMOS) ion-sensitive field-effect transistor (ISFET) for testing a medium, the CMOS ISFET comprising an anti-reflective coating (ARC) layer arranged to interface the medium.

According to another aspect, embodiments described herein can provide a method of making a complementary metal oxide semiconductor (CMOS) ion-sensitive field-effect transistor (ISFET) for testing a medium, the method comprising depositing an anti-reflective coating (ARC) layer arranged to interface the medium.

The depositing may comprise depositing silicon nitride in a complementary metal oxide semiconductor (CMOS) plasma enhanced chemical vapour deposition (PECVD) process. The depositing may comprise depositing at a temperature in the range of 300° C. to 400° C. 5

While specific embodiments have been described above, it will be apparent to one skilled in the art that modifications may be made to the embodiments as described without departing from the scope of the claims set out below. Each feature disclosed or illustrated in the present specification may be incorporated in the embodiments, whether alone or in any appropriate combination with any other feature disclosed or illustrated herein.

1. An ion sensitive field effect transistor (ISFET) for testing a medium, the ISFET comprising:
a substrate;
an active layer located on the substrate;
a source region and a drain region in the active layer;
a gate structure over a channel region between the drain region and the source region;
a backend stack comprising a plurality of metal layers, wherein the gate structure is directly connected to a top metal layer of the plurality of metal layers, and the drain region and source region are directly connected to one or more other metal layer or layers of said plurality of metal layers; and
a sensing layer covering the top metal layer, wherein the sensing layer comprises an anti-reflective coating (ARC) layer arranged to interface the medium.

2. An ISFET according to claim 1, wherein the ARC layer comprises silicon nitride.

3. An ISFET according to claim 2, wherein the ARC layer has a refractive index in the range of 1.90 to 1.94.

4. An ISFET according to claim 1, wherein the ARC layer comprises titanium or tantalum pentoxide.

5. An ISFET according to claim 1, wherein the ARC layer has a thickness in the range of 10 nm to 150 nm.

6. An ISFET according to claim 1, wherein the ARC layer is in direct contact with the top metal layer.

7. An ISFET according to claim 1, wherein the sensing layer further comprises an oxide layer and a nitride passivation layer, wherein the oxide layer is in direct contact with top metal layer and the nitride passivation layer is located between the oxide layer and the ARC layer.

8. An ISFET according to claim 7, wherein the nitride passivation layer has a thickness in the range of 650 nm to 1,000 nm.

9. An ISFET according to claim 7, wherein the oxide layer has a thickness in the range of 500 nm to 1,100 nm.

10. A method of making an ion sensitive field effect transistor (ISFET), the method comprising:
providing a substrate;
providing an active layer located on the substrate;
forming a source region and a drain region in the active layer;
providing a gate structure over a channel region between the drain region and the source region;
providing a backend stack comprising a plurality of metal layers, wherein the gate structure is directly connected to a top metal layer of the plurality of metal layers, and the drain region and source region are directly connected to one or more other metal layer or layers of said plurality of metal layers; and
providing a sensing layer covering the top metal layer, wherein the sensing layer comprises an anti-reflective coating (ARC) layer arranged to interface the medium.

11. A method according to claim 10, wherein the ARC layer comprises silicon nitride.

12. A method according to claim 11, wherein the ARC layer has a refractive index in the range of 1.90 to 1.94.

13. A method according to claim 11, wherein providing the sensing layer comprises depositing silicon nitride in a complementary metal oxide semiconductor (CMOS) plasma enhanced chemical vapour deposition (PECVD) process to form the ARC layer.

14. A method according to claim 13, wherein depositing the silicon nitride comprises depositing at a temperature in the range of 300° C. to 400° C.

15. A method according to claim 10, wherein the ARC layer comprises titanium or tantalum pentoxide.

16. A method according to claim 10, wherein the ARC layer has a thickness in the range of 10 nm to 150 nm.

17. A method according to claim 10, wherein providing the sensing layer further comprises providing an oxide layer and a nitride passivation layer, wherein the oxide layer is in direct contact with top metal layer and the nitride passivation layer is located between the oxide layer and the ARC layer.

18. A complementary metal oxide semiconductor (CMOS) ion-sensitive field-effect transistor (ISFET) for testing a medium, the CMOS ISFET comprising:
an anti-reflective coating (ARC) layer arranged to interface the medium.

19. A method of making a complementary metal oxide semiconductor (CMOS) ion-sensitive field-effect transistor (ISFET) for testing a medium, the method comprising:
depositing an anti-reflective coating (ARC) layer arranged to interface the medium.

20. A method according to claim 19, wherein the depositing comprises depositing silicon nitride in a complementary metal oxide semiconductor (CMOS) plasma enhanced chemical vapour deposition (PECVD) process.

21. A method according to claim 20, wherein the depositing comprises depositing at a temperature in the range of 300° C. to 400° C.
